(19) United States
(12) Patent Application Publication
(10) Pub. No.: US 2003/0128090 A1
(43) Pub. Date: Jul. 10, 2003

(54) Case free ignition apparatus

(76) Inventors: Mark Albert Paul, Fishers, IN (US); Albert Anthony Skinner, Anderson, IN (US)

Correspondence Address: MARGARET A. DOBROWITSKY, DELPHI TECHNOLOGIES, INC., P.O. Box 5052, Mail Code: 480-414-420, Troy, MI, 48007-5052, US

(21) Appl. No.: 10/043,542

(22) Filed: Jan. 10, 2002

(51) Int. Cl. H01F 27/02

(52) U.S. Cl. 336/96

(57) ABSTRACT

A case free ignition apparatus includes a cylindrical-shaped central core with a main axis, a secondary spool radially outwardly of the core, a secondary winding disposed on the secondary spool, a primary spool radially outwardly of the central core and secondary winding, where the primary spool is configured to receive a primary winding on a winding surface thereof. An outer core or shield is received on a flange on the primary spool, and is located radially outwardly of the primary winding, and spaced apart therefrom. A membrane is applied on a radially outer surface of the outer core and is configured so as to seal the ignition apparatus during a subsequent encapsulant filling stage so as to allow the formation of an encapsulant layer between the primary winding and an inner surface of the outer core. Further outer core or shield elements may be added outwardly of the membrane.

### BACKGROUND OF THE INVENTION

1. Technical Field

The present invention relates generally to ignition systems for internal combustion engines, and, more particularly, to a case free ignition apparatus having a primary winding outside of a secondary winding configuration.

2. Description of the Related Art

Known ignition coils utilize primary and secondary windings and a magnetic circuit. The magnetic circuit portion has taken a wide variety of configurations, and is typically constructed using magnetically-permeable material, such as steel laminations or compression molded insulated iron particles. One configuration known in the art comprises an elongated, generally cylindrical core. This slender core is known to be used for so-called “pencil coils,” useful in space limited engine configurations. In a known “pencil” coil, a number of components are typically concentrically arranged and include, from inside to outside, a central core, a secondary spool made of insulating material, a secondary coil wound on the secondary spool, a primary spool, a primary coil wound on the primary spool, an auxiliary core, and a case made from electrical insulating material, as seen by reference to U.S. Pat. No. 5,778,863 issued to Oosuka et al. entitled “IGNITION COIL FOR AN INTERNAL COMBUSTION ENGINE.” Oosuka et al. disclose insulating oil being introduced into the ignition coil, which is further disclosed as causing electrical insulation between the core, secondary coil, primary coil, and the auxiliary core. A shortcoming with the ignition coil of Oosuka et al. and of other conventional similar arrangements is that the main function of the case is merely to act as a container for the insulating material, whether it be insulating oil, epoxy potting material or the like. The case does not act as a dielectric member and in only some cases is it used as a structural member. The case increases material cost as well as enlarges the product, a disadvantage for “pencil” coils.

It is also known to provide an ignition coil that includes a primary coil outside of the secondary coil with an outer core outside of the primary coil but with no case on the outside of the primary winding. A major problem with this ignition coil is that there is no epoxy potting material or the like between the primary winding and the outer core, which leads to erosion of the primary spool due to a so-called corona partial discharge effect, which may lead to the ignition coil failing prematurely.

There is therefore a need for an ignition system that minimizes or eliminates one or more of the problems set forth above.

### SUMMARY OF THE INVENTION

One object of the present invention is to provide a solution to one or more of the problems or address one or more of the challenges set forth above.

One advantage of the present invention is that it provides the benefit of reducing material costs without sacrificing product durability.

An ignition apparatus according to the present invention includes a central core having a main axis, a secondary spool radially outwardly of the core, a secondary winding, a primary spool, a primary winding disposed on the spool, an outer core, and a membrane. The secondary winding is disposed on the secondary spool. The primary spool is disposed radially outwardly of the secondary winding and contains the primary winding. The outer core comprises, in a preferred embodiment, magnetically permeable material (e.g., silicon steel) and is disposed radially outwardly of and spaced apart from the primary winding. The membrane is disposed radially outwardly of the outer core. The membrane, according to the invention, is configured to seal the ignition apparatus so as to contain an encapsulant introduced into the apparatus forming an encapsulant layer, comprising electrical insulating material, between the primary winding and the outer core. The encapsulant layer minimizes harmful erosion due to corona partial discharge. The apparatus eliminates the case, thereby reducing material cost.

Other features, objects, and advantages of the present invention will become apparent to one of ordinary skill in the art in the following detailed description of the invention and accompanying drawings illustrating features thereof by way of example, but not by way of imitation.

### BRIEF DESCRIPTION OF THE DRAWINGS

FIG. 1 is a sectional view of a preferred embodiment of an ignition apparatus according to the present invention.

FIG. 2 is an enlarged section view of a portion of the ignition apparatus of FIG. 1.

FIG. 3 is a section view of the ignition apparatus in FIG. 1 taken substantially along lines 3-3.

### DETAILED DESCRIPTION OF THE PREFERRED EMBODIMENTS

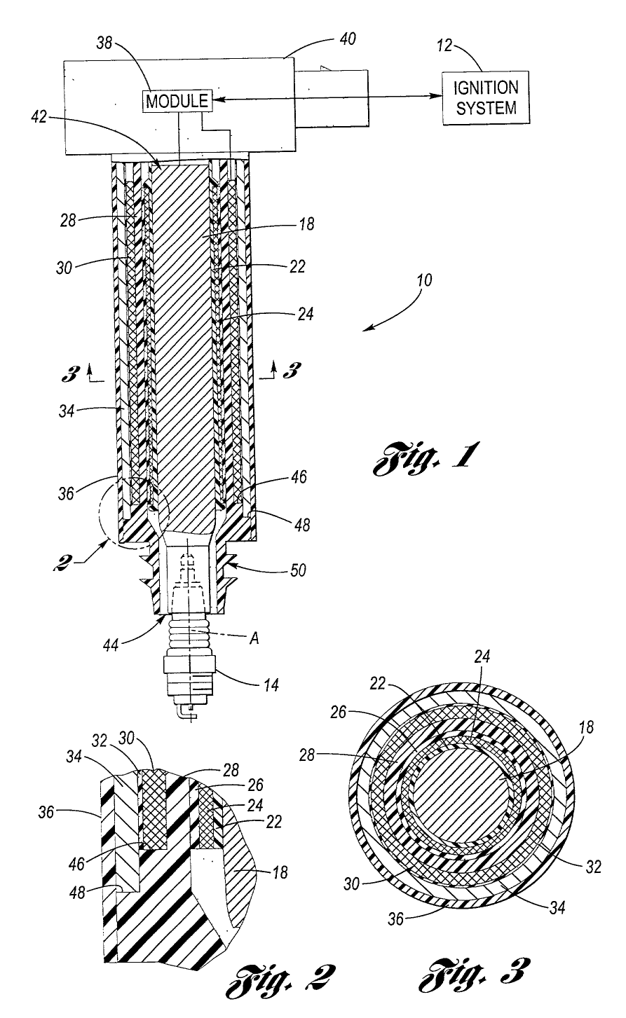

Referring now to the drawings wherein like reference numerals are used to identify identical components in the various views, FIG. 1 is a simplified, cross-section view of an ignition apparatus or coil 10 in accordance with the present invention. As is generally known, ignition apparatus 10 may be coupled to, for example, an ignition system 12, which contains circuitry for controlling the charging and discharging of ignition apparatus 10. Further, also as is well known, the relatively high voltage produced by ignition apparatus 10 is provided to a spark plug 14 for producing a spark across a spark gap thereof defined by spaced electrodes. The spark, of course, may be employed to initiate combustion in a combustion chamber of an internal combustion engine. Ignition system 12 and spark plug 14 perform conventional functions well known to those of ordinary skill in the art.

Ignition apparatus 10 is adapted for installation to a conventional internal combustion engine through a spark plug access well onto a high-voltage terminal of spark plug 14. Spark plug 14 may be retained by a threaded engagement with a spark plug opening in the above-described combustion chamber. The engine may provide power for locomotion of a vehicle, such as an automotive vehicle.

FIG. 1 further shows centrally disposed components 16 (shown in phantom line format), which comprise a central core 18 (shown in FIG. 3) having a main axis designated “A,” a secondary spool 22 (shown in FIG. 3), a secondary winding 24 (shown in FIG. 3), and a first layer of encapsulant such as epoxy potting material 26 (shown in FIG. 3). FIG. 1 further shows a primary spool 28, a primary winding 30, a second layer 32 of encapsulant, such as epoxy potting material, an outer core or shield 34, a membrane 36, and an electrical module 38 contained in a case top 40.

With continued reference to FIG. 1, primary spool 28 is configured to receive and retain primary winding 30. Primary spool 28 includes a first through-hole 42 located at a first end, a second through-hole 44 located at a second end opposite the first end, a first annular flange 46, a second annular flange 48 and, in an alternate embodiment, an integral high voltage (HV) tower 50 molded as a part of primary spool 28. The primary spool 28 is configured, relative to case top 40, so as to allow the primary spool 28 to be press fit into a corresponding, generally circular recess in case top 40.

As described in the Background, a problem with conventional ignition coils of the type that are constructed with the primary winding on the outside of the secondary winding is that the main function of the coil case is to simply act as a container for insulating material, such as insulating oil or epoxy potting material (in the latter case, until the potting material is cured). The case, in conventional designs, acts neither as a dielectric member nor, except in some few designs, as a structural member. In accordance with the present invention, an ignition apparatus 10 is provided that eliminates the coil case that is conventionally placed just outside the main transformer (i.e., central core, primary and secondary windings) and instead provides an arrangement to contain an insulating encapsulant, such as epoxy potting material, during a potting process.

Referring now to FIG. 2, the arrangement referred to above involves installing outer core or shield 34 to the primary spool 28, and further applying membrane 36 to the outside of core 34 to thereby seal the inside of the ignition apparatus 10. In the illustrated embodiment, core 34 engages annular flange 48, is spaced apart from, and is radially outwardly of primary winding 30.

Membrane 36 may comprise a polyester shrink tube, a layer of high temperature tape, or other non-supportive coating configured to provide the sealing function referred to above. Then, electrical insulating material is introduced into the interior of ignition apparatus. In a preferred embodiment, the material comprise epoxy potting material. After the potting material has set, one or more additional outer cores may be placed radially outwardly of membrane 36. Through the foregoing, an ignition apparatus 10 may be provided that eliminates the need for a coil case, thereby reducing the material costs of ignition apparatus 10, without sacrificing durability.

Referring again to FIGS. 1-3, further details concerning ignition apparatus 10 will now be set forth to enable one of ordinary skill to practice the present invention. It should be understood that portions of the following are exemplary only and not limiting in nature. Many other configurations are known to those of ordinary skill in the art and are consistent with the a present invention, which are limited only by the appended claims.

Core 18 may be elongated, having a main, longitudinal axis designated “A” in FIG. 1. Core 18, in the preferred embodiment, takes a generally cylindrical shape (i.e., generally circular shape in radial cross-section).

Spool 22 may comprise a conventional secondary winding spool adopted to receive, for example, a progressive wound secondary winding. Spool 22 may be formed of electrical insulating material, the same as spool 28 described below.

As shown, secondary winding 24 is disposed directly on secondary spool 22. Primary winding 30 is disposed radially outwardly of secondary winding 24, and is wound on primary spool 28. Central core 18, secondary spool 22, secondary winding 24, primary spool 28, primary winding 30, outer core 34 and membrane 36 are arranged substantially coaxially with respect to axis A. Secondary winding 24 includes a low voltage end and a high voltage end. The low voltage end may be connected to a ground by way of a ground connection, for example, through a module 38 in case top 40 in a manner known to those of ordinary skill in the art. The high voltage end may be coupled to an HV connector (not shown) for connection to plug 14.

Primary winding 30 may be wound directly on primary spool 28. Primary winding 30 includes first and second ends and is configured to carry a primary current I_{P} for charging ignition apparatus 10 upon control of ignition system 12. Winding 30 may be implemented using known approaches and conventional materials. Primary spool 28, accordingly, is configured to receive and retain primary winding 30 via annular winding flange 46 on its cylindrical winding surface, for example. Spool 28 is disposed adjacent to and radially outwardly of central components 16 (i.e., comprising core 18, secondary winding 24, and epoxy potting layer 26) and, preferably, is in coaxial relationship therewith. In the illustrated embodiment, spool 28 is configured to receive a continuous primary winding on an outer surface thereof. The spool 28 may be formed generally of electrical insulating material having properties suitable for use in a relatively high temperature environment. For example, spool 28 may comprise plastic material such as PPO/PS (e.g., NORYL available from General Electric) or polybutylene terephthalate (PBT) thermoplastic polyester. It should be understood that a variety of alternative materials may be used for spool 28 known to those of ordinary skill in the ignition art, the foregoing being exemplary only and not limiting in nature.

Layers 26 and 32 comprise an encapsulant suitable for providing electrical insulation within ignition apparatus 10. In a preferred embodiment, the encapsulant comprises epoxy potting material. A variety of thicknesses of the layers 26 and 32 may be possible depending on the dimensions of the components of ignition apparatus 10, as well as the flow characteristics and desired insulating characteristics to be achieved through the use of the encapsulant. The potting material further provides protection from environmental factors which may be encountered during the service life of ignition apparatus 10. There are a number of suitable epoxy potting materials well known to those of ordinary skill in the art.

Outer core 34 is generally annular in shape and preferably comprises magnetically permeable, electrically conductive material, and, more preferably metal, such as silicon steel or other adequate magnetic material. Outer core 34 provides not only a protective barrier for ignition apparatus 10 generally, but, further, provides a return magnetic path for the magnetic circuit portion of ignition apparatus 10. Outer core 34 may be grounded by way of an internal grounding strap, finger, or the like (not shown) or in other ways known to those of ordinary skill in the art. Outer core 34 may comprise additional, individual sheets, outside of membrane 36, as described above.

Electrical module 38 includes primary energization circuitry, such as a switch, for selectively connecting primary winding 30 to ground. The switch may comprise, for example only, an insulated gate bipolar transistor (IGBT) or the like.

Case top 40 is configured to, among other things, seal the top of apparatus 10 and may include a lead frame or the like configured to electrically connect the low voltage end of primary winding 30 to a power source, such as B+, as well as providing an electrical ground to ignition apparatus 10. Case top 40 via such lead frame or other electrical connector is further configured to receive an electronic spark timing (EST) signal from ignition system 12, and provide the same to module 38, which controls conduction of the switch (i.e., when and for how long). Case top 40 is generally formed of electrical insulating material, but may be also includes a plurality of electrically conductive output terminals (e.g., pins for ground, power source, spark timing signal, etc.) that are omitted from FIG. 1 for clarity. Such terminals may be coupled electrically, internally, through case top 40 via the lead frame mentioned above, in a manner known to those of ordinary skill in the art.

Ignition apparatus 10 may also include an HV connector assembly (not shown) for coupling the high voltage developed by secondary winding 24 to spark plug 14. A number of alternative connector arrangements, particularly spring-biased arrangements, are known in the art.

It is to be understood that the above description is merely exemplary rather than limiting in nature, the invention being limited only by the appended claims. Various modifications and changes may be made thereto by one of ordinary skill in the art which embody the principles of the invention and fall within the spirit and scope thereof.

1. An ignition apparatus comprising:
a central core having a main axis;
a secondary winding outwardly of said central core;
a primary spool radially outwardly of said secondary winding;
a primary winding disposed on said spool;
an outer core disposed radially outwardly of and spaced from said primary winding;
a membrane disposed radially outwardly of said outer core; and
an encapsulant layer comprising electrical insulating material between said primary winding and said outer core.

2. The apparatus of claim 1 wherein said spool has respective through-holes at first and second opposing ends and an annular flange at one of said first and second ends configured to be engaged by said outer core.

3. The apparatus of claim 1 wherein said membrane comprises one selected from a high temperature shrink tube, and a layer of high temperature tape.

4. The apparatus of claim 1 wherein said encapsulant comprises epoxy potting material.

5. The apparatus of claim 1 wherein said central core and said outer core comprise magnetically-permeable material.

6. The apparatus of claim 1 wherein said membrane is configured to seal the apparatus so as to contain said encapsulant.

7. The apparatus of claim 3, wherein said selected one is said shrink tube, said tube comprising polyester material.

8. An ignition apparatus comprising:
a cylindrical shaped central core of magnetically-permeable material having a main axis;
a secondary winding on said central core;
a primary winding spool radially outwardly of said secondary winding, said spool having respective through-holes at first and second opposing ends thereof and an annular flange at one of said first and second ends;
a primary winding disposed on said spool;
an outer core of magnetically-permeable material disposed radially outwardly of and spaced from said primary winding, an end of said outer core engaging said annular flange;
a membrane disposed radially outwardly of said outer core; and
an encapsulant layer comprising electrical insulating material between said primary winding and said outer core, wherein said membrane is configured to seal the apparatus so as to contain said encapsulant.
